(19) United States
(12) Patent Application Publication
(10) Pub. No.: US 2004/0101410 A1
(43) Pub. Date: May 27, 2004

(54) Axial flow fluid machine

(76) Inventors: Oleg Naljotov, Brooklyn, NY (US); Vladlen Zitin, Brooklyn, NY (US)

Correspondence Address: Ilya Zborovsky, 6 Schoolhouse Way, Dix Hills, NY, 11746, US

(21) Appl. No.: 10/685,061

(22) Filed: Oct. 14, 2003

Related U.S. Application Data
(63) Continuation-in-part of application No. 09/650,269, filed on Oct. 2, 2001, now Pat. No. 6,632,069.

(51) Int. Cl. F03B 3/12

(52) U.S. Cl. 416/231 R

(57) ABSTRACT

An axial flow fluid machine operating with steam or gas has a stationary housing, a rotor member having an inner disc, an outer shroud, and a plurality of blades mounted between the disc and the shroud, the shroud at least over a part of it being provided with a plurality of throughgoing openings formed so that steam or gas flowing radially outwardly through the openings prevents formation of metal and salt oxides on an inner surface of the outer shroud.

### CROSS-REFERENCE TO A RELATED APPLICATION

This application is a continuation-in-part of application Ser. No. 09/650,269 filed on Oct. 2, 2001.

### BACKGROUND OF THE INVENTION

The present invention relates to axial flow fluid machines, such as for example steam and gas turbines, compressed air plants, and gas force pumps.

In the known axial machines of this type due to the uneven distribution of clearances in shroud seals around the stage, air dynamic shroud and ridge Thomas forces emerge, inducing unstable operation of the turbine rotor and its supports. The inner surface of the rotor blade shroud is subject to the formation of metal and salt oxides, the presence of which closes a portion of the rotor blade open flow area, which leads to the decrease of rated efficiency factor with subsequent reduction of turbine power. Finally, there is excessive fuel consumption, due to the formation of metal and salt oxides. It is therefore believed that it is advisable to eliminate the disadvantages of the prior art.

### SUMMARY OF THE INVENTION

Accordingly, it is an object of the present invention to provide an axial flow fluid machine for use with steam or gas, which eliminates the disadvantages of the prior art.

In keeping with these objects and with others which will become apparent hereinafter, one feature of the present invention resides, briefly stated, in an axial flow fluid machine operating with steam or gas, comprising a stationary housing; a rotor member having an inner disc, an outer shroud, and a plurality of blades mounted between said disc and said shroud, wherein said shroud at least over a part of it is provided with a plurality of throughgoing openings formed so that steam or gas flowing radially outwardly through said openings prevents formation of metal and salt oxides on an inner surface of said outer shroud.

When the axial flow fluid machine is designed in accordance with the present invention it eliminates the disadvantages of the prior art.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a longitudinal section of a turbine pressure stage with shroud seals in a nozzle block shield in accordance with the prior art;

FIG. 2 is a view showing a longitudinal section of a turbine pressure stage with shroud seals located in rotor blade shrouds in accordance with the prior art;

FIG. 3 is a view showing a shroud section of the turbine pressure stage of FIG. 1 in accordance with the present invention;

FIG. 4 is a view showing a shroud section of a turbine pressure stage of FIG. 2 in accordance with the present invention;

FIG. 5 is a view showing a detail A in FIG. 2 in accordance with the present invention, in a section;

FIG. 6 is a view showing a detail of FIG. 1 in accordance with the present invention, in a section.

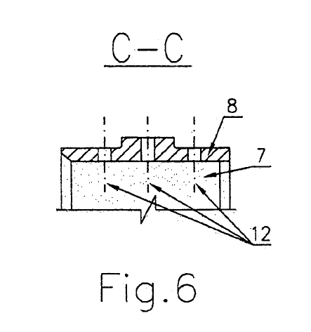

### DESCRIPTION OF THE PREFERRED EMBODIMENTS

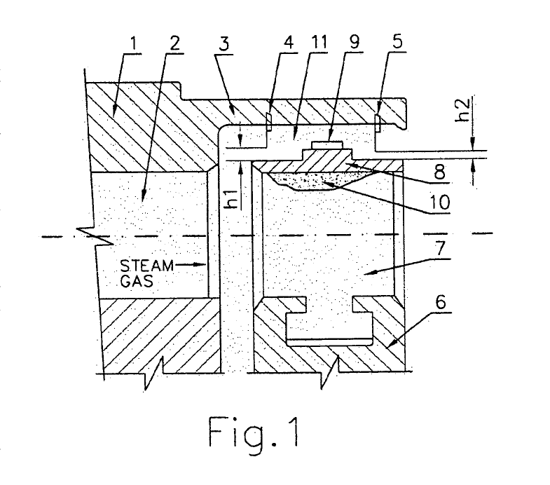

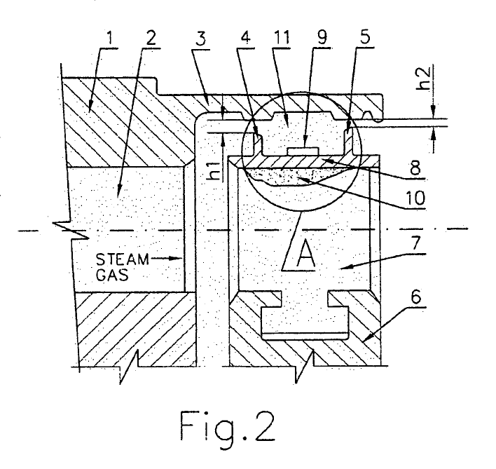

An axial flow fluid machine in accordance with the present invention is illustrated in the drawings in an example of a steam turbine pressure stage. It has a nozzle block 1 with nozzle blades 2 and a shield 3. It further has a rotor wheel including a disc 6, rotor blades 7, a shroud 8, and shroud seals 4 and 5 incorporated in the shield 3 of the nozzle block as shown in FIG. 1 or located on the shroud of the rotor blades as shown in FIG. 2.

The shroud seals of a turbine stage include as a rule two ridges. The first ridge 4 and the second ridge 5 are spaced from one anohter in direction of the flow. They form a shroud chamber 11 with radial clearances h1 and h2 determining the flow rate of steam coming through the seal. Conventionally the clearances h1 and h2 are equal and absolute for each stage or stage group. This value depends on the conditions of thermal expansion of turbine parts, as well as on the condition of the turbo-unit threshold power, i.e. power producing low frequency vibrations.

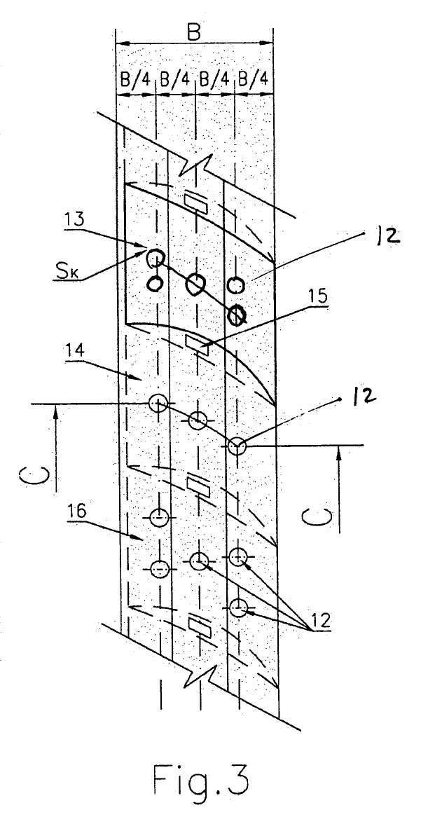

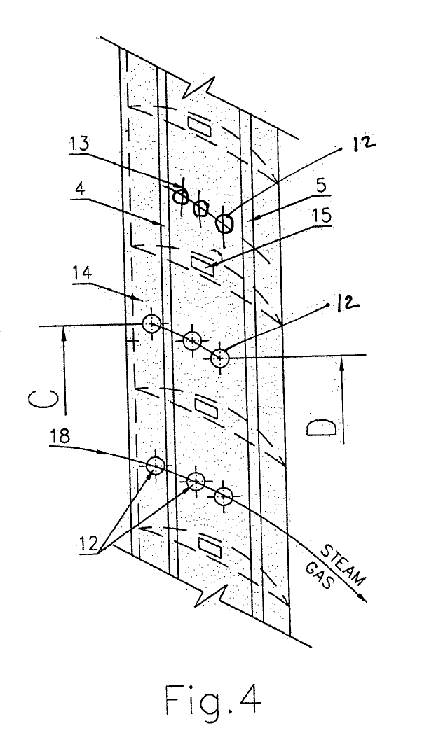

The rotor blade shroud shown in FIGS. 3 and 4 is formed as a strip. It is provided with openings 15 for rotor blade pins 9. Parts of the shroud, covering single flow channel, conventionally do not have any openings. Reference numeral 10 identifies metal and salt oxide formations which are formed on the inner surface of the rotor blade shroud 8 during operation of the turbine.

In accordance with the present invention, the clearances h1 and h2 in the ridges of the shroud seals are formed in such a manner, that the radial seal h2 on the second ridge 5 is smaller than the radial clearance h1 on the first ridge h. This allows to regulate the flow rate of steam coming through the shroud chamber 11 within specified limits.

In accordance with the present invention, at least the parts 13 of the rotor blade shrouds 8 are provided with a plurality of discharge openings 12. They can be formed for example by drilling of the shroud.

The openings 12 can be located in at least a part of the shroud 8. They can be located evenly along some or all the parts 13,14,16 of the shroud 8 following the direction of the steam flow 18 in the inter-blade channel 14 as shown in FIG. 4. The openings 12 can be distributed uniformly as shown for example in FIG. 4, or they can be arranged in staggered order as shown in FIG. 3, depending on the properties of deposits, and their volume as well as on the design of the seals.

The ratio between the number n of the openings 12 and the diameter d of the openings 2 can be as follows:

$$d = 2 \cdot \sqrt{\frac{( 0.02 - 0.50 ) \cdot Sk}{n \cdot π} ,}$$

wherein Sk is a square area of the shroud part covering each single inter-blade channel in the rotor wheel.

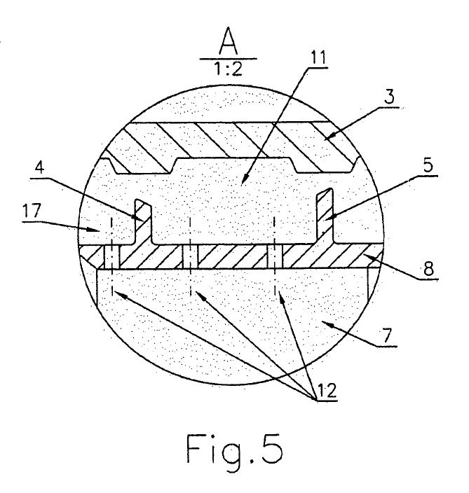

Due to the openings 12 in the shroud 8 of the rotor blades 7, a steam overflow is provided from the chamber 11 located above the shroud and the enclosure 17 also above the shroud as shown in FIG. 5, to the part of the flow channel located under the shroud. This leads to a creation of an obstacle effect, preventing the formation of metal and salt oxides on the inner surface of the shroud.

The discharge of pressure from the chamber 11 located over the shroud and the enclosure 17 of the shroud is implemented by a similar process of steam overflow which excludes the onset of air dynamic Thomas forces above shroud and ridge, thus preventing unstable operation of turbine rotor and its supports. This in turn facilitates the reduction of the radial clearance h2 on the second ridge 5, controlling the turbo-unit threshold power, and provides an additional increase of efficiency factor due to the reduction of steam overflow over the seal.

It will be understood that each of the elements described above, or two or more together, may also find a useful application in other types of constructions differing from the types described above.

While the invention has been illustrated and described as embodied in axial flow fluid machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An axial flow fluid machine operating with steam or gas, comprising a stationary housing; a rotor member having an inner disc, an outer shroud, and a plurality of blades mounted between said disc and said shroud, said shroud at least over a portion of it being provided with a plurality of throughgoing openings formed so that steam or gas flowing radially outwardly through said openings prevents formation of metal and salt oxides on an inner surface of said outer shroud.

2. An axial flow fluid machine as defined in claim 1, wherein said openings are uniformly distributed over said portion of said outer shroud.

3. An axial flow fluid machine as defined in claim 1, wherein said openings are located in a staggered fashion over said portion of said outer shroud.

4. An axial flow fluid machine as defined in claim 1, wherein said openings are selected so that a diameter of said openings corresponds to the following formula:
$$d = 2 \cdot \sqrt{\frac{( 0.02 - 0.50 ) \cdot Sk}{n \cdot π} ,}$$
wherein n is a number of said openings, and Sk is a surface area of said outer shroud.

5. An axial flow fluid machine as defined in claim 1; and further comprising shroud seals including two sealing elements located on an outer surface of said outer shroud or on inner surface of said stationary housing radially facing said outer shroud, said sealing elements providing two radial clearances h1 and h2 between said rotor member and said housing as considered in a flow direction, said clearance h2 being smaller than said clearance h1.
